(19) United States
(12) Patent Application Publication
(10) Pub. No.: US 2012/0124182 A1
(43) Pub. Date: May 17, 2012

(54) METHOD, A TERMINAL, AN ACCESS NODE AND A MEDIA SERVER FOR PROVIDING RESOURCE ADMISSION CONTROL OF DIGITAL MEDIA STREAMS

(76) Inventors: Kim Hyldgaard, Sunds (DK); Ole Helleberg Andersen, Bording (DK); Torben Melsen, Holstebro (DK)

(21) Appl. No.: 13/383,051

(22) PCT Filed: Jul. 10, 2009
(86) PCT No.: PCT/SE09/50890

§ 371 Date: Jan. 31, 2012

(51) Int. Cl. G06F 15/16

(52) U.S. Cl. 709/219

(57) ABSTRACT

Embodiments of the present invention relate to a method and system for providing resource admission control (RAC) of digital media streams between a media server and terminals in a customer premises network. According to an embodiment of the present invention, the method includes receiving from a terminal, a resource request comprising a resource requirement pertaining to a unicast digital media stream request, determining if transmission resources are available for the requested unicast digital media stream based on the resource request, and if so, transmitting a resource availability message pertaining to the unicast digital media stream request to the media server in order for the media server to begin streaming the requested unicast media stream towards the terminal. Embodiments of the present invention further relate to an access node, a terminal and a media server.

### TECHNICAL FIELD

The invention relates to a method for providing resource admission control (RAC) of digital media streams in a communication network. The invention also relates to a terminal, an access node and a media server for providing resource admission control of digital media streams in a communication network.

### BACKGROUND

Multimedia streaming services like IPTV represent a tremendous opportunity for service providers and network operators to deliver a truly personalized service experience to their customers; but, it is also crucial to ensure an adequate Quality of Experience (QoE) for the end-users subscribing to the service. Therefore, a resource admission control (RAC) function is needed to ensure that an end-user is authorized to receive a particular requested media and that the transmission resources needed to provide the particular requested media to the end-user, such as, e.g. sufficient bandwidth, are available. Thus, the RAC function will only allow an end-user to receive the particular requested media if the authorization and resource availability can be verified.

The RAC function is conventionally configured in a central network entity. The central network entity can for example be a broadband network gateway also functioning as a core IP network edge node, or a policy server located in the core IP network as shown in FIG. 1. However, this centralized network configuration will result in high RAC signalling loads on the central network entity and the core IP network when, for example, a large number of end-users are switching between media (e.g. changing IPTV-channels) on their terminals. These high RAC signalling loads may then cause long media or channel change latency periods to be experienced by the end-users, which in turn may generate frustration and complaints. It is thus of high importance to keep the RAC signalling load as low as possible in order to provide an adequate QoE to the end-users. The problem of high RAC signalling loads are most significantly noticed in relation to multicast data traffic or streaming, typically used for broadcast TV and live events.

In order to try and overcome the high RAC signalling loads, another distributed network configuration has been suggested and can be seen in FIG. 2. Here, the RAC function for multicast data traffic or streaming has been partly delegated to the local access nodes. While this distributed network configuration provides a solution with the advantage of eliminating RAC signalling for multicast data traffic or streaming to a centralised network entity, it is not possible for all types of data traffic. Unicast data traffic is for example not distinguishable by a traditional Ethernet Layer-2 local access node. Therefore, a separate RAC function for unicast data traffic still needs to be configured in a central network entity. However, having separate RAC functions for different types of data traffic has disadvantages. For example, this requires that resource information must be synchronised between the multicast RAC function in the access nodes and the unicast RAC function in central network entity in order for both RAC functions to be accurate and function properly. Besides involving a severe risk of having unsynchronized resource databases, this also provides a very complex setup for the configuration and maintenance of the access nodes, the central network entities and the policy servers.

### SUMMARY

A problem to which the invention relates is the problem of achieving a communication network for managing digital media streams with reduced traffic loads and complexity.

This problem is addressed by a method for providing resource admission control (RAC) of digital media streams between a media server and terminals in a customer premises network. The method is characterized by the steps of: receiving from a terminal, a resource request comprising a resource requirement pertaining to a unicast digital media stream request, determining if transmission resources are available for the requested unicast digital media stream based on the resource request, and if so, transmitting a resource availability message pertaining to the unicast digital media stream request to the media server in order for the media server to begin streaming the requested unicast media stream towards the terminal.

The problem is also addressed by an access node for providing resource admission control (RAC) of digital media streams between a media server and terminals in a customer premises network, comprising a resource admission control (RAC) unit and at least one resource data base accessible from the RAC unit and comprising data about transmission resources allocated to the customer premises network. The access node being characterized in that the RAC unit is adapted to receive a resource request comprising a resource requirement pertaining to a unicast digital media stream request from a terminal, determine if transmission resources are available for the requested unicast digital media stream based on the resource request, and if so, transmit a resource availability message pertaining to the unicast digital media stream request to the media server in order for the media server to begin streaming the requested unicast media stream towards the terminal.

The problem is further addressed by a terminal for use in a customer premises network being arranged to request and receive digital media streams from a media server. The terminal being characterized in that it is adapted to, when requesting a unicast digital media stream from the media server, transmit a resource request comprising a resource requirement pertaining to the unicast digital media stream request to an access node connected to the customer premises network such that the access node may detect that the unicast digital media stream request has been sent.

The problem is further addressed by a media server for use in a core IP network in order to establish and transmit digital media streams to terminals in a customer premises network. The media server being characterized in that it is adapted to receive a resource availability message pertaining to a unicast digital media stream request and if the resource availability message correlates with a unicast media stream request received by the media server begin to stream the requested unicast digital media stream associated with the unicast digital media stream request to the terminal.

By having a terminal arranged to, when requesting a unicast digital media stream, transmit a resource request comprising the resource requirement of the unicast digital media stream to an access node, the access node is able to detect and identify whenever the terminal is requesting a unicast digital media stream. By intercepting the resource request, the access node can determine if there are transmission resources available for the requested unicast digital stream in the communication network. If transmission resources are available, the access node may transmit a resource availability message to the media server. The media server may thus, before starting a unicast session of the requested unicast digital media stream towards a terminal, await this resource availability message from the access node. This confirms to the media server that there are transmission resources available for the requested unicast digital media stream. This advantageously enables the access node to function as a policy decision point (PDP) and as a policy enforcement point (PEP) not only for multicast-based services, but also for unicast-based services. Thus, a communication network for managing digital media streams, which has a reduced traffic load and is less complex, is achieved.

An advantage of the invention is that by enabling the unicast and multicast resource admission control (RAC) function to be implemented at the access node, the need for resource synchronisation between the access nodes and the policy server is removed. This eliminates the risk of having unsynchronised resource databases, and facilitates a simplified and less complex configuration and maintenance of both the access nodes and the policy server.

According to one aspect of the invention, the resource requirement of the resource request may be determined using a resource requirements list comprising the relationships between addresses relating to digital media streams and the resources required to convey the related digital media streams to a terminal. This allows the use of functionalities that is already present in the access node for multicast-based services, such as, a whitelist functionality, when determining if there are transmission resources available for the requested unicast digital media stream. The digital media stream may be identified by the access node by having the resource request being made by the terminal using, for example, a dedicated Ethertype. The access node may then recognize and detect the dedicated Ethertype of the Ethernet frame of the resource request and determine the resource requirement for the unicast digital media stream based on the message content of the resource request carrying this recognized Ethertype.

According to a further aspect of the invention, the resource request is a multicast resource request pertaining to the unicast digital media stream request. Having the resource request being a multicast resource request, that is, a resource request used normally for multicast-based services, allows the access node to use already existing functionality in order to identify the unicast resource request. If the multicast resource request is part of IGMP signalling, such as, for example, an IGMP join request, the access node may for example re-use existing IGMP snooping functionality normally employed for multicast-based services in identifying the resource request from the terminal.

By having the terminal configured to use different multicast group addresses or source addresses for different types of digital media streams, the access node may be arranged to determine the resource requirement of the unicast digital media stream comprised in the multicast resource request by simply identifying the multicast group address or the source address of the multicast resource request. This provides an easy and simple determination of the resource requirement in the access node.

The transmission of the resource availability message to the media server by the access node may further comprise encapsulating the resource availability message using a tunnelling protocol, or may utilize a transmission protocol for the resource availability message which is different from the transmission protocol used for receiving the resource request from the terminal. This may be performed when access to the media server is provided through a network level protocol, such as, for example, when provided across a routed IP network, and not being directly connected to the core IP network edge node. This enables for example the media server to be flexibly located anywhere in the core IP network.

The access node or the media server may also be arranged to maintain signalling towards the terminal throughout a subsequent unicast digital media streaming in order to determine whether the requested unicast digital media stream is still utilized by the terminal, or if a previous resource request or resource availability message pertaining to a unicast digital media stream request is invalid. This enables the access node to determine if there are unnecessary resource reservations in the networks. Such unnecessary resource reservations may occur in the network, for example, if an end user switches of the power of the terminal instead of switching the terminal into an idle state. Normally, however, resource reservations are terminated by the terminal by sending a message indicating that the digital media stream is no longer utilized, such as, for example, an IGMP LEAVE signalling. For performing the maintained signalling described above, the access node may comprise an IGMP proxy function, or the media server may comprise an IGMP querier function.

The media server may also be arranged to reject the unicast digital media stream request if the resource availability message pertaining to the unicast digital media stream request is not received from the access node within a predetermined time period. This provides the media server with an easy and simple determination of whether there are resources available for a requested unicast digital media stream in the networks. It may also be arranged to, upon rejecting the unicast digital media stream request, notify the terminal about the cause of the rejection of the unicast digital media stream. This allows the end-user to directly be informed about the reason for the rejection of his unicast digital media stream request.

### BRIEF DESCRIPTION OF THE DRAWINGS

The objects, advantages and effects as well as features of the invention will be more readily understood from the following detailed description of exemplary embodiments of the invention when read together with the accompanying drawings, in which:

FIG. 1 is a block diagram illustrating an example of a communication network managing digital media streams according to prior art.

FIG. 2 is a block diagram illustrating another example of a communication network managing digital media streams according to prior art.

FIG. 3 is a block diagram illustrating an example of a communication network managing digital media streams comprising a terminal, an access node and a media server according to the invention.

FIG. 4 is a signalling diagram illustrating an example of signalling performed between a terminal, an access node and a media server in order to establish a digital media stream according to the invention.

FIG. 5 is a flow chart illustrating an example of how to handle a resource request received from a terminal in an access node according to the invention.

FIG. 6 is a flow chart illustrating an example of how to handle a unicast media stream request received from a terminal in a media server according to the invention.

### DETAILED DESCRIPTION

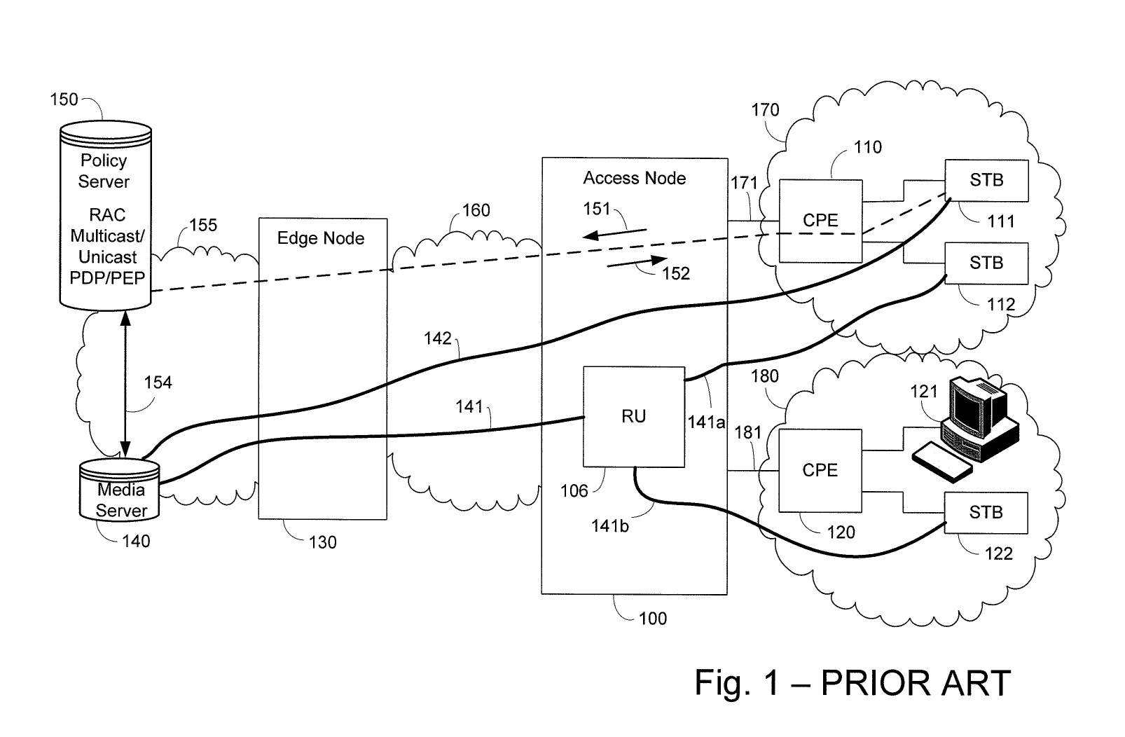

FIG. 1 is a block diagram illustrating an example of a communication network for digital media distribution, such as, for example, IPTV, Video-on-Demand (VoD), radio and other types of media, involving an access node 100. The access node 100 is connected to a regional IP network 160 and a number of customer premises networks 170, 180. The regional IP network 160 may also be referred to as an Ethernet aggregation network. A customer premises network 170, 180 could typically be a home network having a plurality of TV sets and/or computers connected. Each customer premises network 170,180 comprises a customer premises equipment 110,120 CPE. A CPE is a device interfacing access lines 171,181 and can for example be an ADSL modem or a cable modem with router functionality or similar. To each CPE 110,120 a number of terminals such as set-top boxes STB 111,112,122 and personal computers 121 may be connected. Each STB 111,112,122 is connected to a TV set (not shown in FIG. 1). Alternatively, the STB and the TV set may be integrated into the same device. The digital media content for the digital media services is stored in a media server 140. For IPTV, the media server 140 may be referred to as a video server. The media server 140 is connected to a core IP network 155 which is separated from the regional IP network 160 by an edge node 130.

In FIG. 1, the media server 140 is transmitting or streaming a multicast digital video stream 141 towards the STBs 112,122. The multicast digital video stream 141 is duplicated by a replication unit 106 into a first and second video stream 141a, 141b before reaching any of the STBs 112,122. Also in FIG. 1, the media server 140 is transmitting or streaming a unicast digital video stream 142 towards the STB 111. The unicast digital video stream 141 is established and delivered on the application layer protocol level.

When using the concept of dynamic resource control, the resource admission control (RAC) may be implemented in a centralized network resource control entity, here a policy server 150. The resource admission control (RAC) is typically implemented by two basic functions: the policy decision point (PDP) and the policy enforcement point (PEP). The policy decision point (PDP) authorizes and validates resource availability for the digital media streams 141, 141a, 141b, 142 in the communication network. The policy enforcement point (PEP) enforces the decision of the policy decision point (PDP). The PDP and PEP function can, as is shown in FIG. 1, be implemented in the same network element (e.g. the policy server 150), or in different network elements (e.g. the policy server 150 and the Media Server 140). When for example an end-user to STB 111 requests to establish a digital media stream, a request 151 is sent from the STB 111 to the policy server 150. The policy server 150 could then admit or deny the request 151 by responding with an answer message 152 depending on available transmission resources in the communication network. For example, assume in FIG. 1 that STB 112 is located in a home network 170 and is already receiving a multicast digital media stream 141, for example, an IPTV channel. Another end-user having access to the home network 170 desires to establish a unicast digital media stream 142 with a different content using STB 111, for example, a VoD media stream. To achieve this, STB 111 sends a unicast resource request 151 to establish this unicast digital media stream 142 to the policy server 150. Due to transmission resource limitations somewhere in the communication network, the PDP function in the policy server 150 may reject the unicast resource request 151. This will result in that no unicast digital media stream 142 is established to STB 111. The PDP function in the policy server 150 may also determine that there are transmission resources available in the communication network and admit the request, whereby the PEP function in the policy server 150 may communicate 154 with the media server 140 over the core IP network 155 in order to establish the unicast digital media stream 142 between the media server 140 and the STB 111.

In the centralized network configuration shown in FIG. 1, all multicast and unicast resource requests are handled by the centralized PDP function in the policy server 150. This may potentially generate very high signalling loads in the edge node 130, in the core IP network 155 and in the policy server 150. For example, the signalling load on the policy server 150 when a large number of end-users are requesting various digital media streams, such as for example, changing the IPTV channel on their terminals, may result in that long latency periods are experience by the end-users. These latency periods are critical parameters and, if perceived as being too long, are often viewed as annoying and irritating by end-users. This may in turn generate frustration and complaints. It also follows that the centralized network configuration shown in FIG. 1 with a centralized PDP function in the policy server 150 therefore suffers from the disadvantage of being significantly limited in scalability.

These performance problems are mostly present when streaming multicast digital media streams, which is typically used for broadcast IPTV (or linear TV) and live events (e.g. sports events, live concerts, etc.). In the case of unicast digital media streams, such as for example, for VoD requests, where one single end-user is requesting a digital media stream, e.g. a regular movie, an increased latency period before receiving the unicast digital media stream is usually more acceptable by the end-users. Furthermore, the signalling load on the centralized policy server 150, the core IP network 155 and the edge node 130 is typically smaller as the unicast digital video streams (e.g. VoD requests) are more uniformly distributed over time. Therefore, due to the problems with centralized resource admission control (RAC) for multicast-based services, the RAC functionality is often divided into a multicast RAC functionality and a unicast RAC functionality.

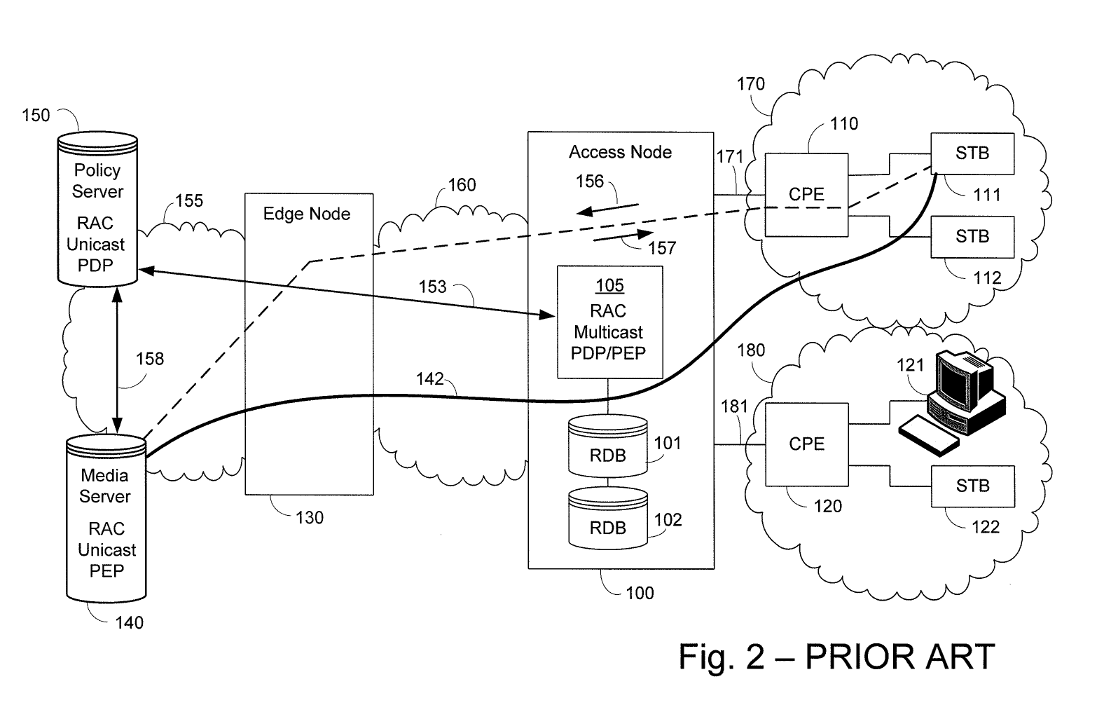

A distributed network configuration as shown FIG. 2 has been suggested. Here, a multicast RAC unit 105 performing both the PDP and the PEP function for multicast digital media streams has been distributed to and implemented in the access node 100. In FIG. 2, the access node 100 is equipped with one or several resource databases RDB 101,102. Here, there is one resource database RDB 101,102 for each customer premises network 170,180, but in other access nodes 100, one common resource data base for all customer premises networks 170,180 could be used. The resource databases RDB 101,102 may comprise information about the transmission resources allocated to each individual customer premises network 170,180 respectively. That is, the transmission resources allocated to each customer premises network 170,180 corresponds to a common pool of available transmission resources for the corresponding terminals 111,112 and 121,122 respectively. The one or several resource databases RDB 101, 102 may further include a resource database (not shown) which may comprise information about the transmission resources allocated to the access node 100 in the regional IP network 160. The multicast RAC unit 105 may be adapted to communicate with the resource databases RDB 101,102 in order to determine if there are transmission resources available for requested multicast digital media stream.

The distribution of the multicast RAC functionality to the access node 100 is made possible because of the fact that multicast-based services typically rely on the Internet Group Management protocol (IGMP) for IPv.4 (or Multicast Listener Discovery protocol (MLD) for IPv.6) for multicast-based service requests. Since traditional Ethernet layer-2 access nodes conventionally comprises an IGMP snooping functionality, it is possible for the local multicast RAC functionality, such as the multicast RAC unit 105, to be implemented at the access node 100. As previously mentioned, one major advantage of having a local PDP/PEP located in the access node 100 is the elimination of RAC signalling to a centralized PDP (e.g. in the policy server 150) for multicast digital media stream requests. This provides a simpler configuration of the communication network and a solution which is more scalable in large deployments.

However, it is fundamental and essential that a communication network configuration encompasses both unicast- and multicast-based services with a coordinated and synchronised resource admission control (RAC) system; otherwise, the admittance/rejection of a multicast/unicast service will be based on erroneous transmission resource availability information. As opposed to multicast-based services, unicast-based services solely use Ethernet unicast frames for both unicast digital media stream requests and unicast digital media content delivery. This type of unicast data traffic is not distinguished by a traditional Ethernet Layer-2 access node, such as, the access node 100, because of the fact that unicast digital media stream requests are handled on the application layer and not on the transmission layer. Therefore, the identification of unicast digital media stream requests amongst the total unicast user plane data traffic would require deep packet inspection (DPI) functionalities to be implemented in the access node 100. Such functionalities however are not normally associated with or desired in the access node 100. Thus, the unicast RAC functionality is conventionally configured in the policy server 150 and the media server 140 in the communication network in FIG. 2. In FIG. 2, when an end-user to STB 111 requests to establish a unicast digital media stream, a unicast resource request 156 may be sent from the STB 111 to the media server 140 or to the policy server 150 directly (not shown in FIG. 2). The media server 140 may communicate 158 with the policy server 150, or vice versa, and the policy server 150 may admit or deny the unicast resource request 156 depending on available resources in the communication network. This may be notified by responding with an answer message 157. If the PDP function in the policy server 150 determines that there are resources available in the communication network and admits the unicast resource request 156, the PDP function in the policy server 150 may communicate 158 with the PEP function in the Media Server 140 over the core IP network 155 such that the PEP function may establish the unicast digital media stream 142 between the media server 140 and the STB 111.

Unfortunately, a problem experienced in such distributed network configurations such as in FIG. 2 is that it requires a resource synchronisation 153 between the multicast RAC unit 105 in the access node 100 and the unicast RAC function in the policy server 150 in order to achieve a coordinated and accurate RAC system. This provides a very complex setup for the configuration and maintenance of the access nodes, the edge nodes and the policy servers. It also involves a severe risk of having resource databases RDB 101, 102 in the access node 100 which are not synchronized with the policy server 150, which as previously mentioned, results in faults in the admittance/rejection of multicast/unicast services in the network.

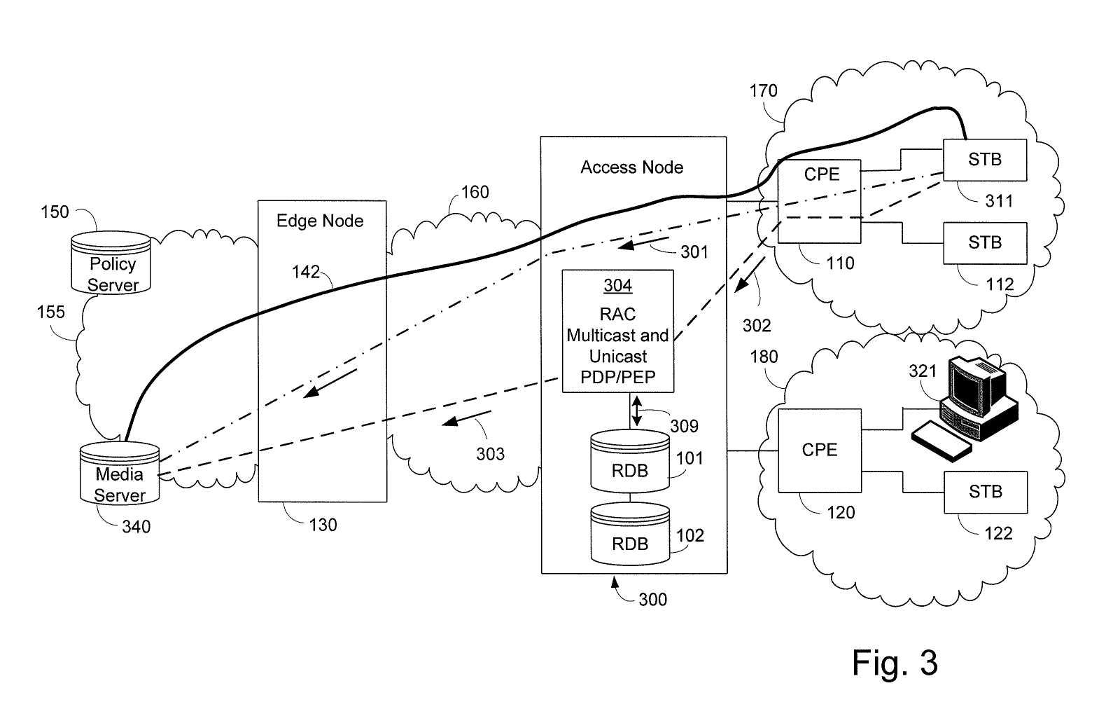

These problems are addressed in embodiments of the invention by receiving in an access node, a resource request from a terminal comprising a resource requirement associated with or pertaining to a unicast digital media stream request that has been made by the terminal. The access node may thus determine if transmission resources are available for the requested unicast digital media stream based on the received resource request. If transmission resources are available for the requested unicast digital media stream, the access node may transmit a resource availability message pertaining to the unicast digital media stream request to a media server. Upon receiving the resource availability message associated with the unicast digital media stream request, the media server may be adapted to compare the resource availability message with requested unicast digital media streams, and if a match is found, begin to stream the requested unicast media stream towards the requesting terminal. This advantageously enables the access node to function as a policy decision point (PDP) and as a policy enforcement point (PEP) not only for multicast-based services, but also for unicast-based services. Thus, a simplified digital media distribution network, which has a reduced traffic load when managing digital media streams and is less complex, is achieved. Further advantageous exemplary embodiments of the invention are described in more detail below with reference to FIGS. 3-6.

FIG. 3 is a block diagram illustrating an example of a communications network managing digital media streams comprising a terminal STB 311, an access node 300 and a media server 340 according to the invention. The access node 300 comprises a resource admission control (RAC) unit 304 and at least one resource data base 101,102 that is accessible by the RAC unit 304. The at least one resource database 101, 102 may comprise information about transmission resources in the communications network, i.e. the core IP network 155, the regional IP network 160 and the customer premises network 170, 180.

In the example shown in FIG. 3 it is assumed for illustrative purposes that the terminal STB 311, sends a unicast digital media stream request 301 to the media server 340. This may be made by the terminal STB 311 in response to inputs from an end-user requesting to view, for example, a Video-on-Demand (VoD) service or another unicast-based service. The unicast digital media stream request 301 is transmitted to the media server 340 using the ordinary unicast setup procedure. An ordinary unicast setup procedure may be described as comprising basically all signalling related to identification of the requested unicast digital media stream 301 and digital rights management related thereto, such as, for example, end user authentication and authorization. Furthermore, this ordinary unicast setup procedure involves using only Ethernet unicast frames and takes place on the application layer. Therefore, this ordinary unicast setup procedure, i.e. the unicast digital media stream request 301, is not detected or identified by the RAC unit 304 in the access node 300 nor is anything else amongst the total amount of unicast user plane data traffic. The media server 340 may be arranged to receive the unicast digital media stream request 301 and wait for a resource availability message 303 to arrive from the access node 300. The media server 340 may also be arranged to proceed with the ordinary unicast setup procedure towards the terminal STB 311 up to a particular point, i.e. anywhere up until before the actual unicast digital stream starts to be streamed, and then wait for the resource availability message 303 to arrive.

In association with the transmittal of the unicast digital media stream 301 to the media server 340, the terminal STB 311 is also arranged to send a resource request 302 to the access node 300. The resource request 302 may comprise resource requirement information about the unicast digital media stream 301 sent to the media server 340, that is, how much transmission resources that is required in the communication network for streaming the requested unicast digital media stream 301 from the media server 340 to the terminal STB 311. The resource request 302 may be any type of resource request suitable to transfer or indicate the resource requirement of the unicast digital media stream 301 to the RAC unit 304 in the access node 300.

According to an embodiment of the invention, a resource request 302 according to the above may be made using the Internet Group Multicast Group (IGMP) protocol, herein referred to as a multicast resource request. IGMP exists in three versions 1 to 3 which are specified in the internet standards RFC1112, RFC2236 and RFC3376 respectively. IGMP was developed such that access nodes 300 and other intermediary nodes (like routers etc, not shown in FIG. 3) may know towards which terminals data packets of multicast digital media streams must be replicated. The RAC unit 304 in the access node 300 is arranged to detect and identify a multicast resource request transmitted by the terminal STB 311 according to the invention. This may be performed by re-using the IGMP snooping functionality conventionally implemented in the access node 300 which allows them to detect and identify multicast resource requests, that is, IGMP signals. Thus, the RAC unit 304 in the access node 300 is arranged to detect and identify the multicast resource request which carries or indicates the resource requirement information associated with the unicast digital media stream request 301. If, however, the access node 300 as shown in FIG. 3 does not support an IGMP snooping functionality, the reference to an access node in this description and in the claims may also refer to the same described functionality when located in a customer premises equipment CPE 110 or even a multicast router (BNG) (not shown) in the customer premises networks 170, 180.

For multicast resource requests according to the above, the access node 300 may maintain a resource requirements list comprising the relationships between multicast group addresses or group source addresses and the resources required to convey the related digital media streams to the terminals, such as, the terminal STB 311. The resource requirements list may, for example, be located in the at least one resource database 102, 103 or in the RAC unit 304. The resource requirements list may be implemented as an expansion to an existing Whitelist, which is commonly used in an access node for admission control of multicast-based services, or as a separate resource requirements list. The multicast group addresses or group source addresses in the resource requirements list in the access node 300 may indicate different types of unicast digital media streams, such as, for example, one address identifying unicast digital media streams requiring 10 Mbps, another address in identifying unicast digital media streams requiring 4 Mbps, etc. Thus, the terminal STB 311 may be configured to indicate the transmission resources required for a unicast digital media stream requested in the unicast digital media stream request 301 to the RAC unit 304 in the access node 300, by sending the multicast resource request using a particular multicast group address or group source addresses.

In addition to a relation between addresses relating to digital media streams and the resources required to convey the digital media streams to the terminals, the resource requirements list may further comprise a listing of which multicast media streams the end-users are authorized to see (usually implemented in the whitelist). However, for the purpose of the invention described herein, only the relationships between digital media streams and the required resources needs to be used, since authorisation may continuously be handled by the media server 340. Furthermore, the IGMP protocol has basically two types of connection control messages, Join and Leave. Join is sent from a terminal that requests to establish a media stream and Leave is sent from the terminal when it wants to release a media stream. The resource request 302 may for example be an IGMP Join request.

According to another embodiment of the invention, a resource request 302 according to the above may also be made using, for example, a dedicated Ethertype or similar digital identifier. In this case, the RAC unit 304 in the access node 300 may be arranged to recognize and detect the relevant Ethertype of the resource request 302, i.e. by interpreting received Ethernet frames as a resource request if comprising the dedicated Ethertype or similar digital identifier. The resource requirement may then be comprised in or indicated by the message content of the resource request. For this purpose, the resource requirements list may be used in a similar manner as above for determining the resource requirement of the requested unicast digital media stream. Alternatively, the resource requirements list in the access node 300 may be adapted to comprise certain Ethertypes indicating different types of unicast digital media streams, such as, for example, one Ethertype for identifying unicast digital media streams requiring 10 Mbps, another Ethertype for identifying unicast digital media streams requiring 4 Mbps, etc. Thus, the RAC unit 304 in the access node 300 is configured to determine the transmission resources required for a unicast digital media stream requested in the unicast digital media stream request 301 by receiving a resource request using a particular Ethertype or similar digital identifier from the terminal STB 311.

In the case where the media server 340 is not in direct connectivity with the regional IP network 160, i.e. the media server 340 does not have a Layer-2 point-to-point connectivity with the access node 300 through the edge node 130, the RAC unit 304 may be adapted to convey the resource availability message 303 to the media server 340 through an at least Layer-3 network level protocol over the core IP network 155 and the regional IP network 160. According to one alternative this may be performed by, for example, encapsulating the resource request 303 using a tunnelling protocol where Layer-2 traffic is tunnelled through the Layer-3 network. This alternative may advantageously also be used when the resource request 302 is made using IGMP signalling, i.e. multicast resource requests. Another option is to utilize an application layer protocol for the resource availability message 303 that may be different from the protocol used for receiving the resource request 302 from the terminal 311, such as, for example, a Session Initiation Protocol (SIP). This may advantageously be used when the resource request 302 is made using a dedicated Ethertype or similar digital identifier, whereby the resource request 302 may be provided to the media server 340 directly by, for example, sending it to an IP address of the media server 340. In any case, the resource request 302 and the resource availability message 303 may be identical, or comprise substantially the same content. This enables a simple and easy configuration of the resource availability message 303 in the access node 300.

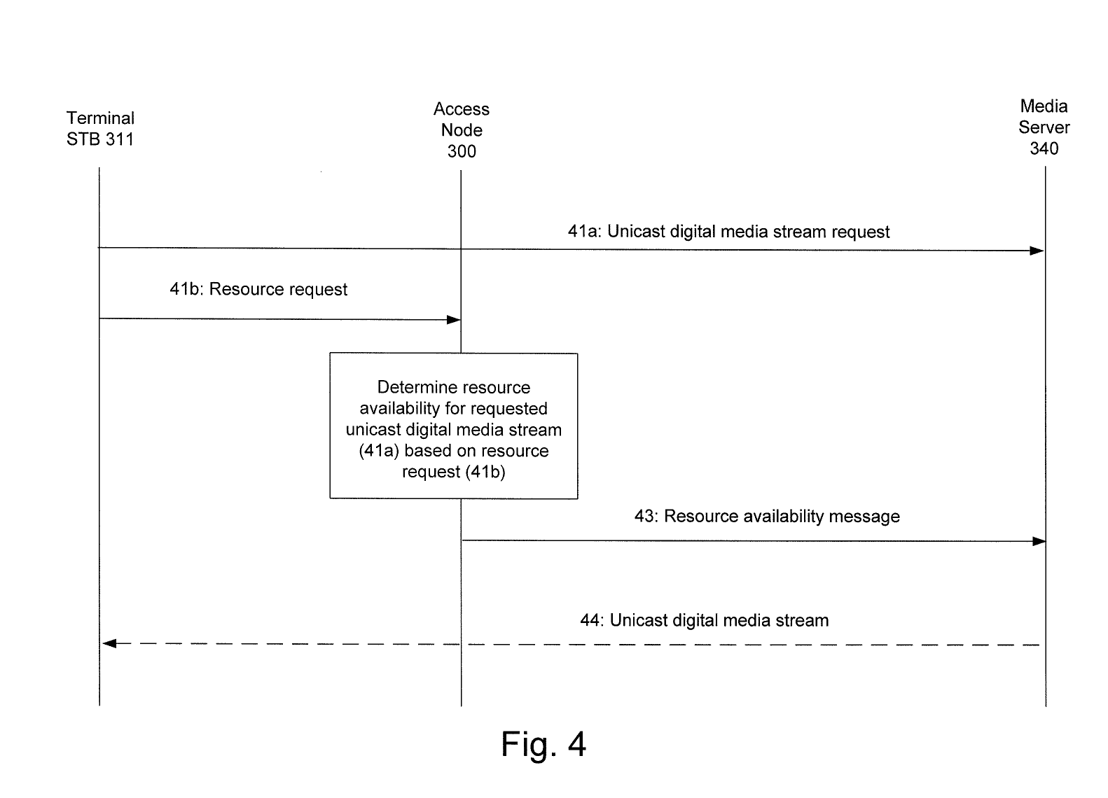

FIG. 4 is a signalling diagram illustrating an example of signalling performed between a terminal, an access node and a media server in order to establish a digital media stream according to the invention.

As a request for a unicast based service is made by the end-user of the terminal STB 311, the terminal STB 311 transmits a unicast digital media stream request 41 a to the media server 340 through the access node 300 requesting a digital media stream 44. The media server 340 receives the unicast digital media stream request 41a. Simultaneously or at least in association with the transmittal of the unicast digital media stream request 41a, the terminal STB 311 also transmits a resource request 41b to the access node 300. The resource request 41b is received by the RAC unit 304 in the access node 300.

The RAC unit 304 in the access node 300 may then determine if there are transmission resources available in the communication network for the unicast digital media stream 44 that was requested in the unicast digital media stream request 41a that was transmitted to the media server 340. This may be performed by the RAC unit 304 by using the information in the resource request 41b pertaining to the unicast digital media stream request 41a. If the RAC unit 304 in the access node 300 determines that there is transmission resources available in the communication network for the unicast digital media stream 44 requested in the unicast digital media stream request 41a to the media server 340, the RAC unit 304 in the access node 300 may transmit a resource availability message 43 to the media server 340. The media server 340 may receive the resource availability message 43 and establish and begin to stream the requested unicast digital media stream 44 towards the terminal STB 311. However, if the RAC unit 304 in the access node 300 determines that there is not enough transmission resources available in the communication network for the unicast digital media stream 44 requested in the unicast digital media stream request 41 a to the media server 340, the RAC unit 304 in the access node 300 will not transmit any resource availability message 43 to the media server 340. Thus, in this case, since the media server 340 always will wait for a resource availability message 43 to arrive from the access node 300 before beginning to stream the requested digital media stream 44, no digital media stream 44 will be established.

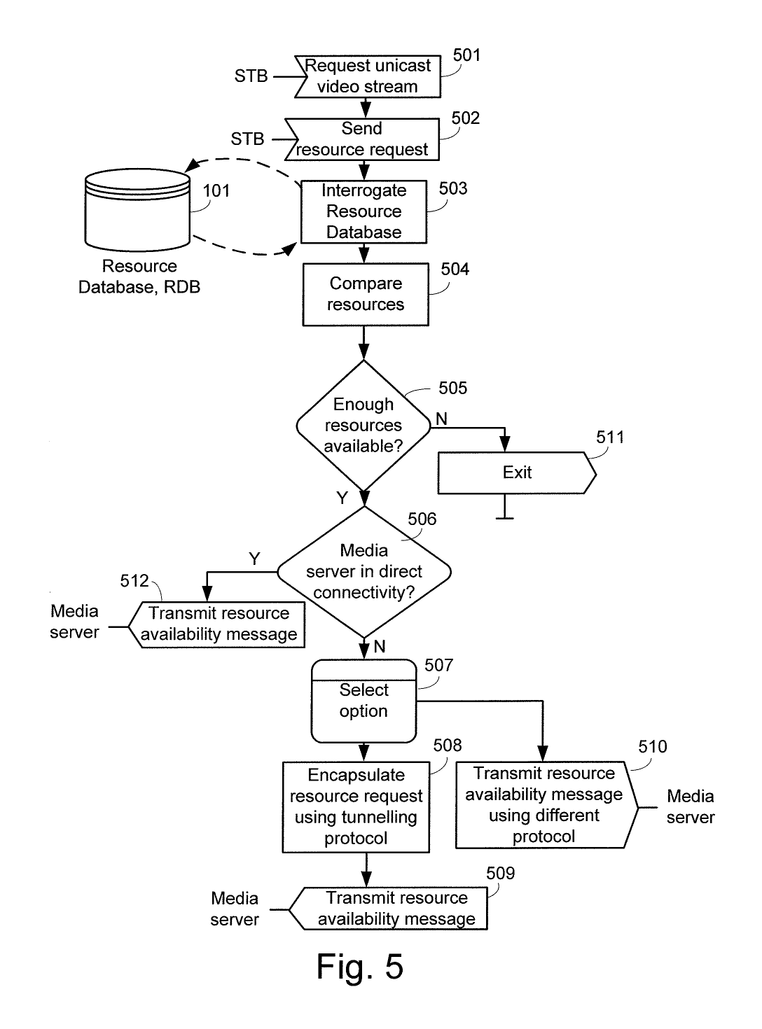

FIG. 5 is a flow chart illustrating an example of how to handle a resource request from a terminal in an access node according to the invention. In step 501, the terminal STB 311 sends a unicast digital media stream request to the media server 300. In step 502, the terminal STB 311 also sends a resource request pertaining to the unicast digital media stream request to the access node 300.

In step 503, the access node 300 receives the resource request from the terminal STB 311 and may interrogate its resource database 101 in order to find out the amount of currently available transmission resources in the communication network, i.e. the core IP network 155, the regional IP network 160 and the customer premises networks 170,180. When the access node 300 has determined the currently available transmission resources in the communication network, the access node 300 may in step 504 compare the currently available transmission resources with the transmission resources required to convey the requested digital media stream to the terminal STB 311. In step 505, if there is enough currently available transmission resources for conveying the requested digital media stream to the terminal STB 311, the access node 300 may proceed to step 506. Otherwise, the access node 300 may proceed to step 511 and exit the operations initiated in the access node 300 by the reception of the resource request. In step 506, the access node 300 may determine if the media server 340 is in direct Layer-2 connectivity with the regional IP network 160 and thus with the access node 300. If the media server 340 is in direct Layer-2 connectivity with the regional IP network 160, the access node 300 may proceed to step 512 and send a resource availability message to the media server 340, which may start to establish and stream the requested digital media stream to the terminal STB 311. However, if the media server 340 is not in direct connectivity with the regional IP network 160, the access node 300 may proceed to step 507.

In step 507, the access node 300 may select how to transmit the resource availability message to the media server 340 based on the characteristics of the resource request, that is, for example, if the resource request is made using IGMP signalling or a dedicated Ethertype or any other type of signalling indicating a resource request of a requested unicast digital media stream. The selected option in step 507 may also depend upon the configuration of the core IP network 155 and the regional IP network 160, and may be dynamically selected during operation or set upon implementing the invention. According to a first option, the access node 300 may be arranged to encapsulate the resource availability message and use a tunnelling protocol for transmitting it to the media server 340 in step 509. According to a second option, the access node 300 may be arranged to, in step 510, send the resource availability message using another transmission protocol (e.g. SIP) than the protocol that was used to transmit the resource request from the terminal STB 311 to the access node 300. The resource availability message may here be sent directly to the IP-address of the media server 340. The transmission protocol may be selected in dependence of the configuration of the core network 155 and regional IP network 160 between the access node 300 and the media server 340.

It should be noted that although the flowchart above include several different alternatives, any one of these alternatives may be chosen to be fixedly implemented in the terminal STB 311, the access node 300 and/or the media server 340. This would obviously render some of the steps in the flowchart superfluous for some particular embodiments.

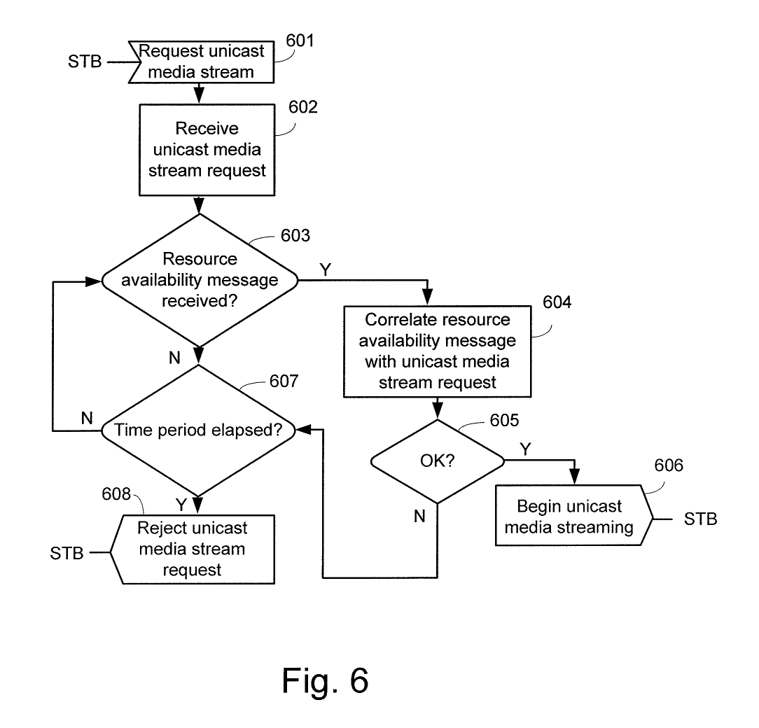

FIG. 6 is a flow chart illustrating an example of how to handle a unicast media stream request from a terminal in a media server according to the invention. In step 601, the terminal STB 311 sends a unicast digital media stream request to the media server 300. In step 602, the unicast digital media stream request is received by the media server 300.

In step 603, prior to establishing and/or initiating the streaming of the requested digital media stream towards the terminal STB 311 using an ordinary unicast setup and streaming procedure, the media server 300 is arranged to check whether or not a resource availability message has been received from the access node 300. In step 604, if a resource availability message has been received, the media server 300 may correlate the resource availability message with the unicast digital media stream request, that is, check if the resource availability message pertains to (i.e. is associated with) the unicast digital media stream request. It should also be noted that the media server 340 may also still be arranged to handle access authorisation for the unicast digital media stream, i.e. determine if the terminal STB 311 is authorised to receive the requested unicast digital media stream. In step 605, if the resource availability message does pertain to the unicast digital media stream request, the media server 300 may in step 606 begin to establish and/or initiate the streaming of the requested digital media stream towards the terminal STB 311. The media server 300 may also be arranged to maintain signalling towards the terminal STB 311 throughout the unicast session of the unicast digital media stream in order to determine whether the requested unicast digital media stream is still utilized by the terminal STB 311. This maintained signalling may also be used to determine if a previous resource request or a resource availability message pertaining to a unicast digital media stream request is invalid.

However, if no resource availability message has been received by the media server 300 which pertain to the unicast digital media stream request, the media server 300 may in step 607 check whether a predetermined time period for receiving the resource availability message for the requested digital media stream has elapsed. This may also be performed by the media server 300 if no resource availability message was received in step 603.

In step 607, if no resource availability message pertaining to the requested unicast digital media stream is received within the predetermined time period, the media server 300 may reject the unicast digital media stream request from the terminal STB 311. This may be performed on the application layer and as a part of the ordinary unicast setup and streaming procedure. The media server 300 may also be arranged to include an indication of the cause of the rejection towards the terminal STB 311, which may indicate to the terminal STB 311 that there is not enough resources in the communication network at the moment for the requested unicast digital media stream.

It should be noted that the invention may operate independent of the configuration of the Virtual Local Area Network (VLAN) architecture of the regional IP network 160, such as, for example, a N:1 or 1:1 VLAN configuration model as described in “Technical Report 101: Migration to Ethernet-based DSL aggregation”, April 2006, DSL Forum/Broadband Forum. In an exemplary embodiment of the invention, it may be suitable to use a specific VLAN for unicast transmissions, which may comprise both resource requests and data traffic flow, and another VLAN for strictly multicast transmissions. However, when using IGMP signalling for the resource availability message, it must be ensured that the IGMP messages in fact can traverse the entire regional IP network. It follows that IGMP suppression must not be enabled in the regional IP network switches or aggregation network switches. This is also known as transparent IGMP handling. Although, note that this requirement is only applicable to the specific VLAN in which the IGMP messages are sent; other VLANs may support other IGMP handling schemes, for example, IGMP suppression.

The description above is of the best mode presently contemplated for practising the invention. The description is not intended to be taken in a limiting sense, but is made merely for the purpose of describing the general principles of the invention. The scope of the invention should only be ascertained with reference to the issued claims.

1-18. (canceled)

19. A method in an access node for providing resource admission control (RAC) of digital media streams between a media server and terminals in a customer premises network, comprising the steps of:
receiving from a terminal, a resource request comprising a resource requirement pertaining to a unicast digital media stream request,
determining if transmission resources are available for the requested unicast digital media stream based on the resource request and if so,
transmitting a resource availability message pertaining to the unicast digital media stream request to the media server in order for the media server to begin streaming the requested unicast media stream towards the terminal.

20. A method according to claim 19, wherein the resource requirement of the resource request pertaining to the unicast digital media stream request is determined using a resource requirements list comprising the relationships between addresses relating to digital media streams and the resources required to convey the related digital media streams to the terminal.

21. A method according to claim 20, wherein the resource request is made using a dedicated Ethertype, further comprising the steps of:
detecting the resource request pertaining to the unicast digital media stream request by the resource request comprising a dedicated Ethertype,
determining the resource requirement of the resource request pertaining to the unicast digital media stream request based on the content of the resource request comprising the dedicated Ethertype.

22. A method according to claim 19, wherein the resource request is a multicast resource request pertaining to the unicast digital media stream request.

23. A method according to claim 22, wherein the resource requirement of the multicast resource request pertaining to the unicast digital media stream request is determined by the multicast group address or the source address of the multicast resource request.

24. A method according to claim 22, wherein the multicast resource request is part of IGMP signalling, such as, an IGMP join request.

25. A method according to claim 19, wherein the step of transmitting the resource availability message further comprises:
encapsulating the resource availability message using a tunnelling protocol when access to the media server is provided through a network level protocol, such as, over a routed IP network.

26. A method according to claim 19, wherein the step of transmitting the resource availability message further comprises:
utilizing a transmission protocol different from the transmission protocol used for receiving the multicast resource request from the terminal for the resource availability message, when access to the media server is provided through a network level protocol, such as, over a routed IP network.

27. A method according to claim 19, further comprising the step of:
maintaining signalling towards the terminal throughout the unicast digital media streaming in order to determine whether the requested unicast digital media stream is still utilized by the terminal or if a previous resource request or a resource availability message pertaining to a unicast digital media stream request is invalid.

28. An access node for providing resource admission control (RAC) of digital media streams between a media server and terminals in a customer premises network, comprising a resource admission control (RAC) unit and at least one resource data base comprising transmission resource information accessible from the RAC unit, wherein the RAC unit is adapted to
receive a resource request comprising a resource requirement pertaining to a unicast digital media stream request from a terminal, determine if transmission resources are available for the requested unicast digital media stream based on the resource request, and if so, transmit a resource availability message pertaining to the unicast digital media stream request to the media server in order for the media server to begin streaming the requested unicast media stream towards the terminal.

29. An access node according to claim 28, comprising an IGMP proxy function arranged to determine whether the requested unicast digital media stream is continuously utilized by the terminal or if a previous resource request pertaining to a unicast digital media stream request is invalid throughout the unicast digital media streaming.

30. A terminal for use in a customer premises network being arranged to request and receive digital media streams from a media server, wherein the terminal is adapted to,
when requesting a unicast digital media stream from the media server, transmit a resource request comprising a resource requirement pertaining to the unicast digital media stream request to a resource admission control (RAC) unit in an access node connected to the customer premises network such that the resource admission control (RAC) unit in the access node may detect that the unicast digital media stream request has been sent.

31. A terminal according to claim 30, wherein the resource request is a multicast resource request, such as, an IGMP join request, or is made using a dedicated Ethertype.

32. A terminal according to claim 31, wherein the resource requirement of the multicast resource request pertaining to the unicast digital media stream request is defined by the multicast group address or the source address of the multicast resource request.

33. A media server for use in an core IP network in order to establish and transmit digital media streams to terminals in a customer premises network, wherein the media server is adapted to
receive a resource availability message pertaining to a unicast digital media stream request and if the resource availability message correlates with a unicast media stream request received by the media server begin to stream the requested unicast digital media stream associated with the unicast digital media stream request to the terminal.

34. A media server according to claim 33, comprising a IGMP querier function arranged to determine whether the requested unicast digital media stream is continuously utilized by the terminal, or if a previous resource request pertaining to a unicast digital media stream request is invalid, throughout the unicast digital media streaming.

35. A media server according to claim 33, further adapted to reject the unicast digital media stream request if the resource availability message pertaining to the unicast digital media stream request is not received within a predetermined time period.

36. A media server according to claim 35, further adapted to, upon rejecting the unicast digital media stream request, notify the terminal about the cause of the rejection of the unicast digital media stream.
